(19) United States
(12) Patent Application Publication
(10) Pub. No.: US 2008/0110290 A1
(43) Pub. Date: May 15, 2008

(54) Handlebar repositioning mount for recreational vehicles

(76) Inventor: Charles Leo Buettner, Ramsey, MN (US)

Correspondence Address: Michael A. Mochinski, Suite 514, 3300 Bass Lake Road, Brooklyn Center, MN, 55429, US

(21) Appl. No.: 11/983,269

(22) Filed: Nov. 8, 2007

Related U.S. Application Data
(60) Provisional application No. 60/858,259, filed on Nov. 9, 2006.

(51) Int. Cl. B62K 21/18

(52) U.S. Cl. 74/551.8

(57) ABSTRACT

A handlebar repositioning mount for a recreational vehicle, which comprises top and bottom mount surfaces rigidly supported by at least two planar elements of unequal length that consequentially establish an angular orientation of the bottom mount surface relative to the top mount surface. The top and bottom mount surfaces each comprising first and second sets of apertures extending therethrough and arranged in a manner to coincide with first and second arrangements of apertures generally present in a handlebar mount assembly and a column support plate of a steering column assembly, respectively, wherein the bottom mount surface is fastened to the column support plate and the top mount surface is fastened to a lower clamping plate of the handlebar mount assembly, the final assemblage of which increases the height and alters the angular orientation of a handlebar set more upright and vertical consequentially contributing to safe operation of the recreational vehicle.

### CROSS-REFERENCE TO RELATED APPLICATIONS

This application claims the benefit of U.S. Provisional Patent Application No. 60/858,259, filed Nov. 9, 2006, entitled “Handlebar Repositioning Mount for Recreational Vehicles,” the disclosures of which, including all attached documents, are incorporated herein by reference in their entirety for all purposes.

### FIELD OF THE INVENTION

The present invention relates in general to a handlebar repositioning mount suited for adaptation to a steering column assembly and handlebar set generally associated with and present in stock and modified recreational vehicles, such as a snowmobile, an all-terrain vehicle, and a jet ski. More specifically, the handlebar repositioning mount is located and mounted inline with the steering column assembly of the recreational vehicle to increase the stock height and alter the stock angular position of the handlebar set to make recreational and competitive use of the recreational vehicle more safe, comfortable, and enjoyable for a greater number of users.

### BACKGROUND OF THE INVENTION

A recreational vehicle such as a snowmobile is characteristically known in the art as a specialized vehicle suited for traversing terrain covered with snow, principally being propelled by a motor driven rear track and steered by a handlebar set integrally associated with a steering column assembly having two front skis connected therewith which collectively function to maneuver the vehicle toward the desired direction of travel. These open air vehicles generally accommodate one to two riders and a driver who straddle about the span of a vehicle's seat. Handling and principal operation of the snowmobile as well as other recreational vehicles may involve the driver's forward reach of both arms to engage the handlebar set to permit steering of the vehicle while simultaneously affording an opportunity to manage hand controls mounted on or adjacent to the handlebar set, primarily being directed to start, propel and stop the vehicle. Typical hand controls associated with a recreational vehicle, for example, may include an ignition switch, throttle, hand operated brake controls, and lastly the handlebar set itself to manage left- and right-hand turning of the vehicle.

First created as a utility vehicle for transport of persons, snowmobiles have increasingly grown in popularity to coincidentally establish two additional identifiable uses of the vehicle: one for recreational use and another for competitive use. By the nature of the activities, each identifiable use is recognizably associated with drastically different needs and requirements for safe and efficient operation of the vehicle. Further, the popularity of snowmobiling in and of itself has greatly expanded the number and diversity of participants categorically identified with each of the identifiable uses.

For instance, recreational use of the snowmobile may primarily center on family- or social-orientated activity of fun and enjoyment of the outdoors. An enthusiast engaged in recreational use of the snowmobile may solely be concerned with the reliable performance, safety, comfort, appearance, and ease of use of the vehicle, and accordingly, may seek and utilize a variety of available aftermarket accessories that enhances one or more of these concerns. One example of an accessory with broad appeal to the recreational user is miniature windshields that adaptably attach to the outermost handle portion of the handlebar set. This type of aftermarket accessory effectively serves as a wind block to comfortably keep an operator's hands warm during operation of the snowmobile. Concurrently, this type of device may alter or at least distinguish the appearance of the snowmobile. A handlebar pad, also available as an aftermarket accessory, may reduce the likelihood of frontal injury should the operator of a snowmobile inadvertently strike the handlebar set during a stopping maneuver, for example.

In like manner, an enthusiast seeking competitive use of the snowmobile may demand maximum vehicle performance centered on speed, handling and maneuverability, and accordingly, like that of the enthusiast engaged in recreational use of the snowmobile, may seek aftermarket accessories to complement the snowmobile's standard operative features and equipment to gain a competitive edge in racing events, for example. Manufacturers of snowmobiles have come to recognize the enthusiasts' demands for performance and, as such, have appropriately equipped vehicles that can handle the rigors of competition, but with recognizable limitations.

Regardless of the snowmobile's use in recreational activities, competitive events or transport of a person, manufacturers of snowmobiles generally cater to the broadest purchasing segment for these vehicles. The structural characteristics of many of the standardized vehicles offered by manufacturers do not necessarily coincide or accommodate the unique physical attributes of each and every enthusiast presently participating in snowmobiling. Now more than ever a prospective enthusiast entering into the recreational use or the sport of competitive racing of a snowmobile may vary significantly in terms of height, size, shape, and pre-existing physical or athletic ability. In particular, taller riders may be physically challenged by the standard position of the handlebar set on most snowmobiles. This is an unacceptable market condition because maintaining a comfortable operating position is integral to the safe operation of the vehicle, particularly among enthusiasts involved in competitive, high-speed racing of snowmobiles or enthusiasts simply involved in prolong recreational use of the snowmobile.

In order to safely operate any snowmobile for any extended period of time, an operator must be comfortably positioned in an upright manner, particularly in such manner which affords an opportunity to view the environmental conditions or immediate surroundings to take immediate corrective action if deemed necessary in times of an emergency or crisis situation. If the handlebar set is positioned too low relative to one's physical structure, he or she may have a tendency to slump forward in order to maintain continued control of the vehicle. Consequentially associated with this position, the operator may view less of the terrain ahead focusing at some point below the horizon. To compensate, the operator may have a tendency to lift his or her head slightly to permit increased viewing of the horizon, which in turn, creates an awkward position of the neck and shoulders and over an extended period of vehicle operation can cause acute discomfort. Slumping forward also causes undue stress on the wrist and hands already tasked with griping the handlebar set and operating the throttle, breaking, and steering mechanism all while absorbing the vibration of the vehicle and any changes experienced in terrain.

The one size fits most approach clearly is not working for a large segment of the recreational vehicles available to the enthusiast, including that of snowmobiles. The art offers a variety of devices that permit re-orientation of the handlebar set to accommodate the physical attributes of the operator, but with notable limitations. The simplest of these devices may be a spacer block or an extension member mountably located inline of the steering column assembly, a configuration of which merely extends the handlebar set more angularly toward the operator without further alteration of the angular position thereof to achieve a more vertical position for safe operation of the vehicle. Any advantage gained in elevating the height of the handlebar set is immediately negated by the closer proximity this device places the handlebar set to the operator, unnecessarily of which establishes an uncompromising position of his or her arms. This uncompromising position becomes more apparent for an operator of taller stature, wherein the upward, elevated position of the handlebar set places the operator's elbows in a more outwardly extended position causing even greater fatigue and possibly an even greater risk of injury from striking a passing object, such as a tree limb.

An alternative device that is suited to raise the handlebar set, yet comprises means for angular adjustment thereof, involves usage of an assembly of a pair of extensions each having upper and lower knurled clamps with the upper knurled clamp serving to engage a midsection portion of the handlebar set and the lower knurled clamp serving to engage a portion of the steering column assembly. In its instance of use, it can be extremely difficult to coordinate the positioning of all the required parts to make any meaningful improvement to the operator's condition. Although the alternative device may be suited to meet the demands for adjustability of the handlebar set in most respects, it is inherently complex and costly to manufacture and is susceptible to failure, especially when constantly acted upon in an environment of great vibration. Further, by its own intricate design, the alternative device may exacerbate the impact of smaller incidents such as striking the handlebar set with a passing object or pulling on the handlebar set during extreme maneuvers as four points of failure can increase the need to make positioning adjustments.

Accordingly, there remains a need for a handlebar repositioning mount that is suited for adaptation to a steering column assembly and handlebar set generally associated with and present in stock and modified recreational vehicles, a handlebar repositioning mount which inherently increases the height and alters the angular position of the stock handlebar set to establish a more vertical orientation thereof which consequentially increases one's comfort and safety during operation of the recreational vehicle.

### BRIEF SUMMARY OF THE INVENTION

In order to overcome the numerous drawbacks apparent in the prior art, a handlebar repositioning mount has been devised for stock and modified recreational vehicles, such as a snowmobile, an all-terrain vehicle, and a jet ski.

It is an object of the present invention to provide a handlebar repositioning mount that readily adapts and fits to a steering column assembly and a handlebar set generally associated with and collectively present in a recreational vehicle.

It is an object of the present invention to provide a handlebar repositioning mount capable of repositioning the handlebar set in a more vertical orientation for increased comfort during operation of a recreational vehicle.

It is yet another object of the present invention to provide a handlebar repositioning mount that is solidly and rigidly constructed to offer reliable, long-term performance.

It is another object of the present invention to provide a handlebar repositioning mount that comprises a lesser number of components and no moving parts which collectively equate to a lesser cost of manufacture and reduced susceptibility to failure.

It is another object of the present invention to provide a handlebar repositioning mount that complements and can coexist with other aftermarket accessories known in the art and directed to altering a recreational vehicle's stock steering column assembly and handlebar set.

It is yet another object of the present invention to provide a handlebar repositioning mount that requires no continued or repeated adjustments to retain its height and angular position even in the event of the handlebar set's inadvertent contact or engagement with a passing object.

It is yet another object of the present invention to provide a handlebar repositioning mount which accomplishes the foregoing and other objects and advantages and which is economical, durable, and fully effective in performing its intended functions without unduly compromising the stock performance and operation of the recreational vehicle.

In accordance with the present invention a handlebar repositioning mount has been devised for adaptation to a steering column assembly and handlebar mount assembly generally associated with and present in stock and modified recreational vehicles, the handlebar repositioning mount preferentially comprising top and bottom mount surfaces rigidly supported by and integrally connected to at least two planar elements of unequal length which principally establish an angular orientation of the bottom mount surface relative to the top mount surface, the top and bottom mount surfaces each comprising first and second sets of apertures extending therethrough and selectively arranged in a manner to coincide and align with first and second arrangements of apertures generally present in the handlebar mount assembly and a column support plate of the stock steering column assembly, respectively, wherein the bottom mount surface is preferentially situated to engage the stock column support plate for fastening therewith by means of supplementary mount bolts and the top mount surface is preferentially situated to engage a lower clamping plate of the stock handlebar mount assembly for fastening therewith by means of stock mount bolts, the final assemblage of which affirmatively increases the height and alters the angular orientation of a handlebar set associated with the handlebar mount assembly in a more upright, vertical position to make recreational and competitive use of the recreational vehicle more safe, comfortable, and enjoyable for a greater number of users.

Other objects, features, and advantages of the present invention will become apparent in the following detailed description of the preferred embodiments thereof when read in conjunction with the accompanying drawings in which like reference numerals depict the same parts in the various views.

### BRIEF DESCRIPTION OF THE SEVERAL VIEWS OF THE DRAWINGS

A preferred embodiment of the present invention will now be described by way of example with reference to the accompanying drawings, in which:

FIG. 1 is a side perspective view of the preferred embodiment of the present invention illustrating a handlebar repositioning mount having top and bottom mount surfaces integrally connected to first and second planar elements;

FIG. 2 is a top plan view of the preferred embodiment of the present invention illustrating a top mount surface having a first set of apertures extending therethrough for receiving stock mount bolts;

FIG. 3 is a side elevational view of the preferred embodiment of the present invention illustrating a handlebar repositioning mount situated in between and connected to a steering column assembly and a handlebar mount assembly of a snowmobile;

FIG. 4 is a perspective view of the preferred embodiment of the present invention illustrating a handlebar repositioning mount situated in between and mounted to a column support plate and a lower clamping plate of a handlebar mount assembly;

FIG. 5 is a front elevational view of the preferred embodiment of the present invention illustrating pre-assembly of two handlebar repositioning mounts selectively situated in a side-by-side relation and collectively mounted in between a stock column support plate and a stock handlebar mount assembly associated with a handlebar set of a recreational vehicle;

FIG. 6 is a bottom plan view of the preferred embodiment of the present invention illustrating a bottom mount surface having a second set of apertures extending therethrough for receiving supplementary mount bolts;

FIG. 7 is a side perspective view of a first, alternative embodiment of the present invention illustrating a handlebar repositioning mount having top and bottom mount surfaces integrally connected to a single planar element;

FIG. 8 is a side perspective view of a second, alternative embodiment of the present invention illustrating a handlebar repositioning mount having top and bottom mount surfaces integrally connected to first and second sideward members;

FIG. 9 is a side perspective view of a third, alternative embodiment of the present invention illustrating a handlebar repositioning mount having top and bottom mount surfaces integrally connected to an inward support member;

FIG. 10 is a side view of the preferred embodiment of the present invention illustrating a stock steering column assembly and a stock handlebar mount assembly mountably located inline along L₁; and

FIG. 11 is a side view of the preferred embodiment of the present invention illustrating an offset relationship of a stock steering column assembly mountably located inline along L₁ and a stock handlebar mount assembly mountably located inline along L₂, as principally established by the presence of a handlebar repositioning mount.

### DETAILED DESCRIPTION OF THE INVENTION

While this invention is susceptible of being embodied in many different forms, the preferred embodiment of the invention is illustrated in the accompanying drawings and described in detail hereinafter with the understanding that the present disclosure purposefully exemplifies the principles of the present invention and is not intended to limit the invention to the embodiments illustrated and presented herein. The present invention has particular utility as a handlebar repositioning mount that is suited for adaptation to a steering column assembly and a handlebar mount assembly generally associated with and present in a recreational vehicle, particularly of which increases the stock height and alters the stock angular orientation of a handlebar set associated with the handlebar mount assembly in a more upright, vertical orientation consequentially contributing to increased comfort and safety during one's operation of the recreational vehicle.

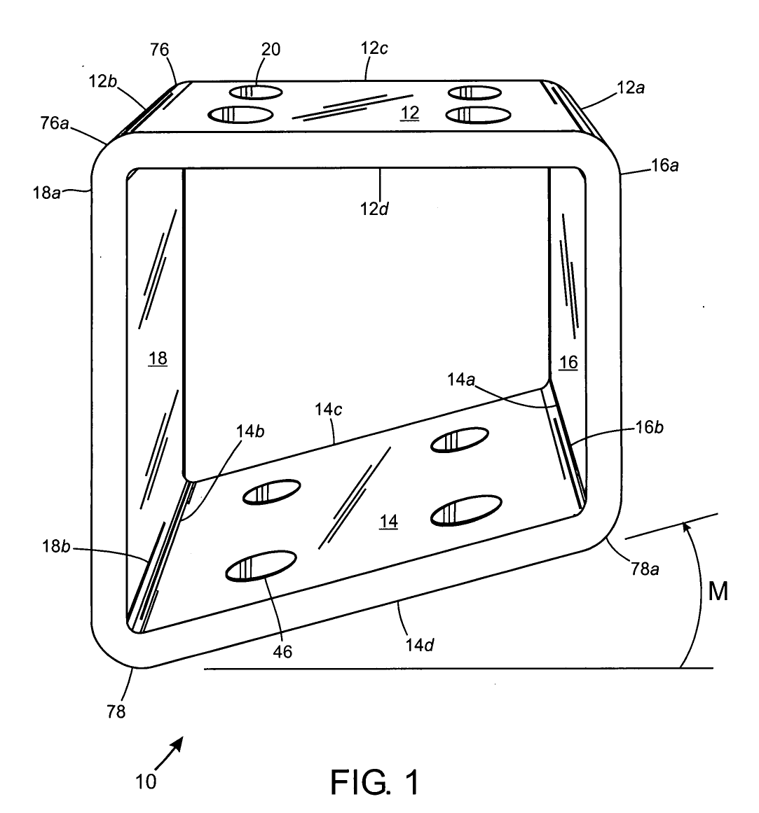

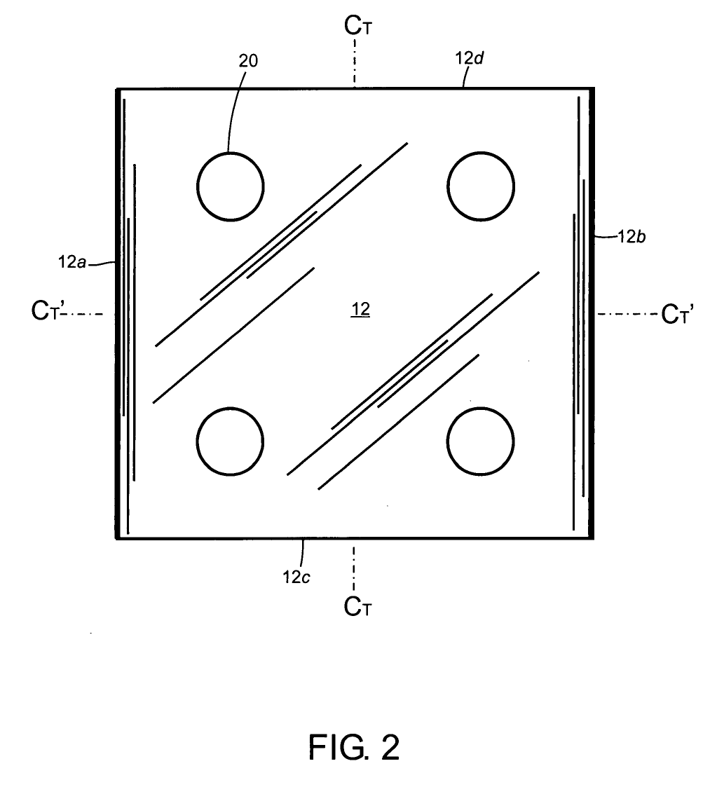

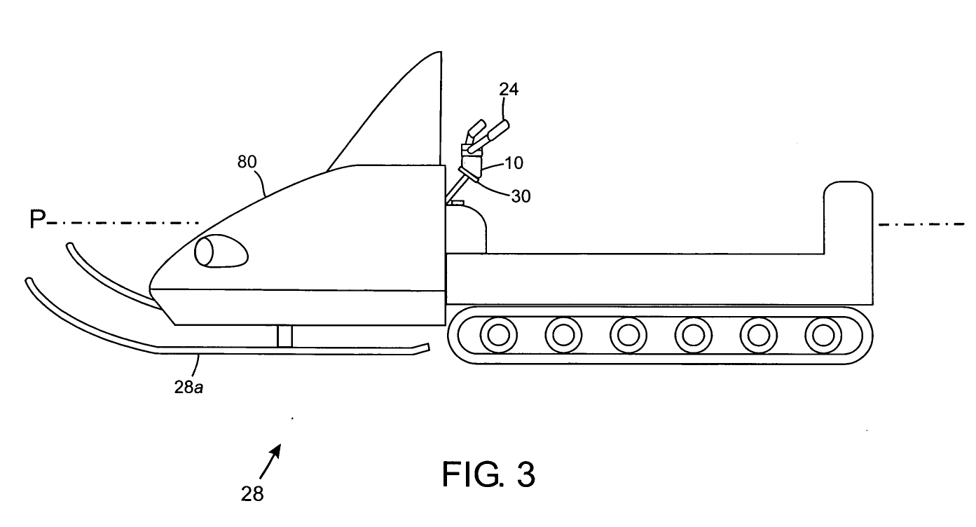

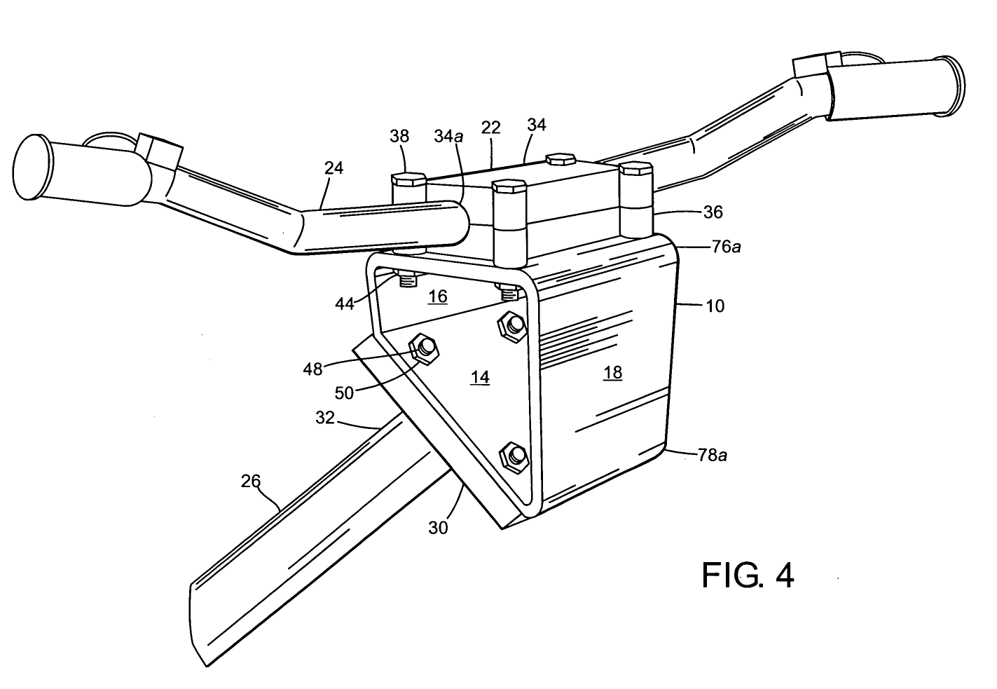

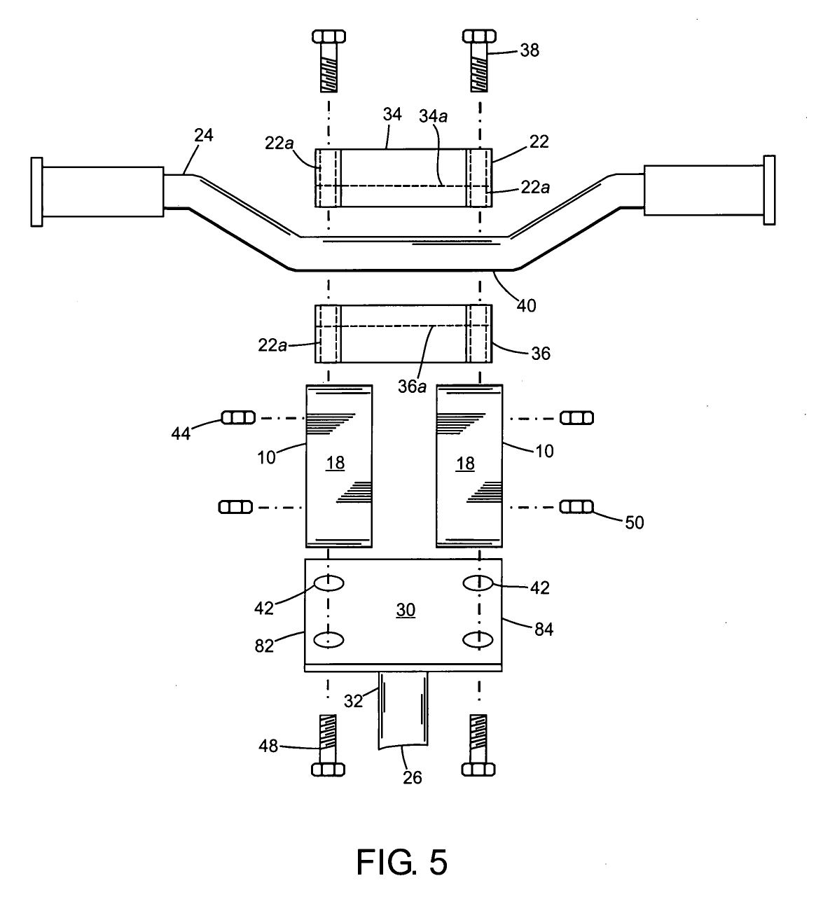

Referring now to FIG. 1, there is shown generally at 10 at least one handlebar repositioning mount comprising top and bottom mount surfaces 12, 14 rigidly supported by at least two planar elements 16, 18, with each planar element generally having an equal width substantially corresponding to the width of the top and bottom mount surfaces and an unequal length to foundationally establish an angular orientation of the bottom mount surface relative to the top mount surface. The top mount surface is further shown in FIG. 2 to comprise fore and aft leading edges 12a, 12b which integrally connect with and terminate at upper leading edges 16a, 18a of the first and second planar elements, respectively. In the preferred embodiment of the present invention, the first and second planar elements 16, 18 are vertically orientated to the top mount surface 12 upon their union therewith the first and second planar elements generally being situated apart in a parallel relation to one another. The top mount surface is further shown to comprise a first set of apertures 20 extending therethrough and suitably arranged in a manner to coincide and align with a first arrangement of apertures 22a generally present in a stock handlebar mount assembly 22 to attach a stock handlebar set 24 to a stock steering column assembly 26, as particularly associated with and present in a stock recreational vehicle, such as a snowmobile 28 of the type shown in FIG. 3, an all-terrain vehicle, and a jet ski. It is specifically noted herein that the handlebar repositioning mount 10, as illustrated in FIG. 4 and described elsewhere herein, is preferably mounted in between a column support plate 30 integrally attached to and associated with an upper end 32 of the stock steering column assembly and the stock handlebar mount assembly 22. Although not described herein with particularity, the other end of stock steering column assembly 26 may comprise linkage means (not shown) for connecting the steering column assembly to skis 28a of a snowmobile or a wheel or wheels of an all-terrain vehicle to appropriately serve in allowing an operator to turn the vehicle in the desired direction of travel, for example. As schematically represented in FIG. 5, the stock handlebar mount assembly 22 is generally shown to comprise upper and lower clamping plates 34, 36 with each clamping plate having a concave runner 34a, 36a traversing centrally and longitudinally thereabout. The first arrangement of apertures 22a, as shown in association with the stock handlebar mount assembly in FIG. 4, are positioned about the corners thereof and extend through the clamping plates to receive therein an equal number of stock mount bolts 38 of the type preferentially used to fasten the stock handlebar mount assembly 22 directly to the column support plate 30 of the stock steering column assembly. Assembly of the stock handlebar mount assembly, which involves the upper clamping plate 34 being placed atop the lower clamping plate 36, substantially yields an aligned relationship of the concave runners 34a, 36a to circumferentially fit about and engage a midsection portion 40 of the handlebar set 24 where it is tighteningly secured in place by means of mount bolts 38 positioned into the stock handlebar mount assembly 22 and extending therebeyond and through a second arrangement of apertures 42 of the stock column support plate 30 for fastening with appropriately configured hex nuts 44 or equivalent or alternatively into threaded apertures (not shown) of the column support plate without the requirement of hex nuts.

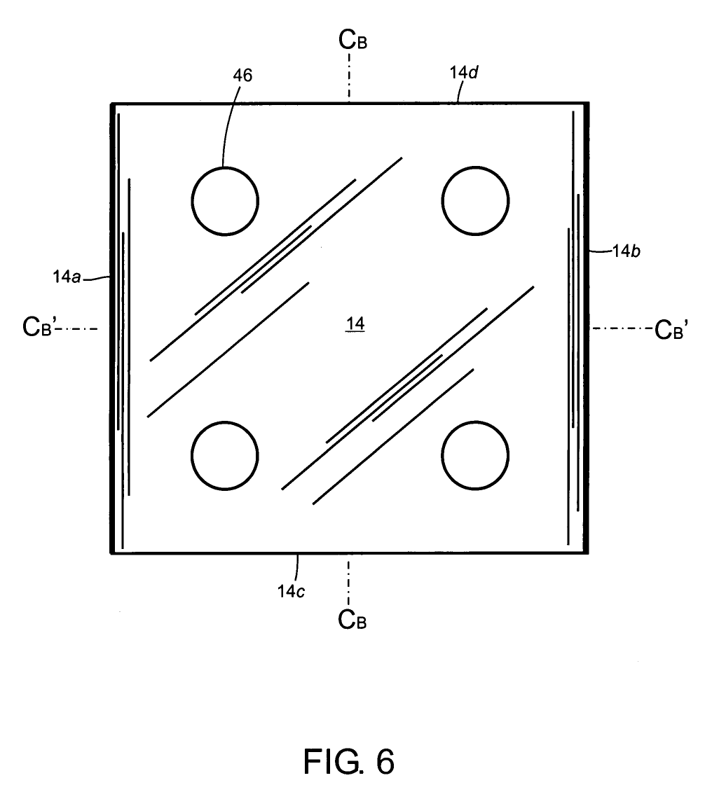

Referring now to FIG. 6, the bottom mount surface 14 of the handlebar repositioning mount 10 is shown to comprise fore and aft leading edges 14a, 14b which integrally connect with and terminate at bottom leading edges 16b, 18b of the first and second planar elements 16, 18, respectively. The length differential between the first and second planar elements principally establishes the angular orientation of the bottom mount surface relative to the top mount surface 12, as preferentially shown in FIG. 1. In the preferred embodiment, the bottom mount surface is angularly orientated 10° to 45° from a line extending parallel to the positioning of the top mount surface, as specifically depicted by path M in FIG. 1. The adaptation of a particular angular orientation selected from within the noted range principally depends on the established angular orientation of the stock steering column assembly 26 and desire to attain a more upright, vertical orientation of the handlebar set 24, namely where the top mount surface is generally orientated more horizontal and parallel to longitudinal axis P of the recreational vehicle shown in FIG. 3. To permit connection of the handlebar repositioning mount 10 to the stock steering column assembly, the bottom mount surface 14, as shown in FIG. 6, further comprises a second set of apertures 46 extending therethrough and suitably arranged in a predetermined manner to coincide and align with the second arrangement of apertures 42 generally present in the column support plate 30 of the stock steering column assembly 26. A supplementary number of bolts 48 fitted through the aligned apertures of the bottom mount surface 14 and the column support plate and affixed with appropriately configured hex nuts 50 sufficiently serve as means to consummate the connection of the handlebar repositioning mount 10 to the stock steering column assembly.

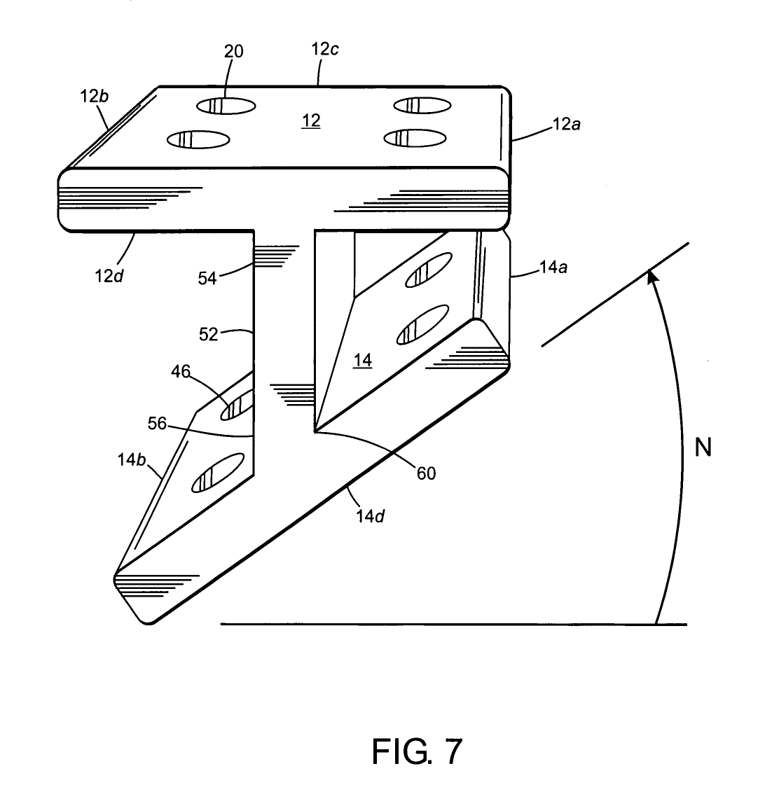

Referring now to FIG. 7, the handlebar repositioning mount 10 may be reflected in a first, alternative embodiment wherein the top and bottom mount surfaces 12, 14 are rigidly supported and integrally held together by means of a single planar element 52 to substantially yield a sideward profile resembling an I-beam. In this particular embodiment, the single planar element, which comprises an upper end 54 and a lower angular end 56, is selectively positioned to extend perpendicular to the left and right sides of the top and bottom mount surfaces and is fixedly attached to each mount surface substantially along centerlines C_{T}, C_{B} extending midway in between and parallel to the fore and aft leading edges, as depicted in FIGS. 2 and 6. In order to establish the angular orientation of the bottom mount surface, notably to the likes described for the preferred embodiment, the lower angular end of the single planar element 52 comprises an angled profile 60 having an angular value ranging 10° to 45° from a line extending parallel to the positioning of the top mount surface 12, as substantially illustrated by path N in FIG. 7. It is therefore contemplated by the first, alternative embodiment that the select angular value for the angled profile translates to the preferred angular positioning of the bottom mount surface 14 relative to the top mount surface 12 to achieve a more vertical orientation of the handlebar set 24 to the likes of the preferred embodiment shown in FIG. 4.

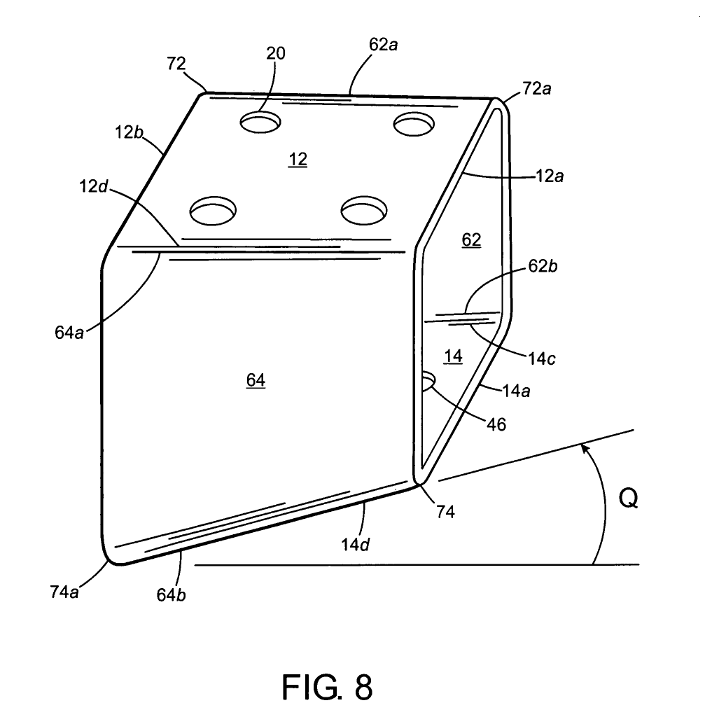

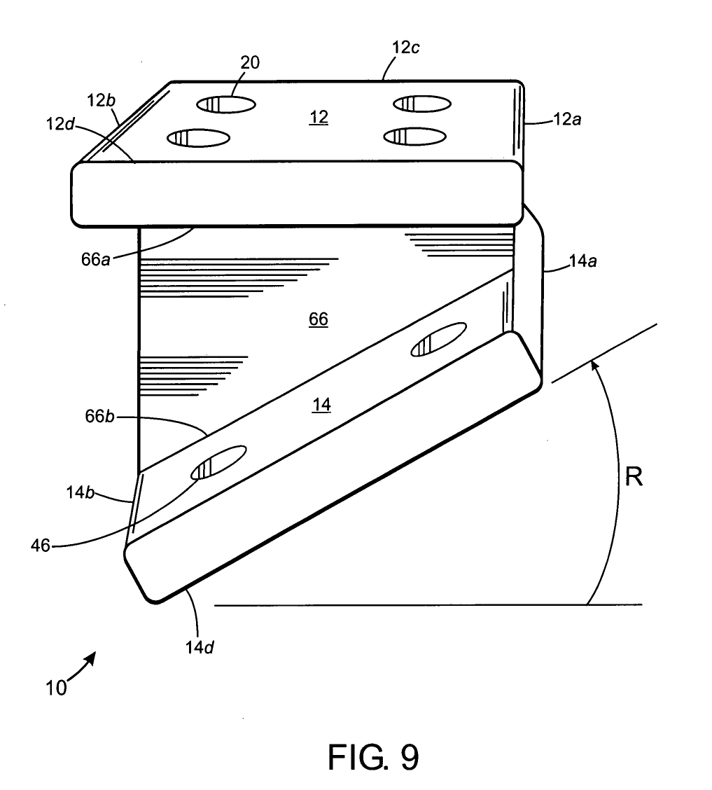

Referring now to FIGS. 8 and 9, it is further contemplated herein that the handlebar repositioning mount 10 may be represented in yet two additional, alternative embodiments, wherein the two planar elements 16, 18 of the preferred embodiment thereof and the single planar element 52 of the first, alternative embodiment thereof are selectively orientated perpendicular to the fore and aft leading edges of the top and bottom mount surfaces.

In the instance of the second, alternative embodiment of the handlebar repositioning mount 10, the first and second planar elements 16, 18 are modified to form first and second sideward members 62, 64, each of which comprising a top end 62a, 64a and an angular bottom end 62b, 64b having an angular value ranging 10 to 45 degrees from a line extending parallel to the top mount surface, as illustrated by path Q in FIG. 8. In an assembled state, left and right sides 12c, 12d, 14c, 14d of the top and bottom mount surfaces 12, 14 are integrally joined to the top ends 62a, 64a and the angular bottom ends 62b, 64b of the first and second sideward members to substantially yield a corresponding angular position of the bottom mount surface relative to the top mount surface.

Similarly, in the instance of the third, alternative embodiment of the handlebar repositioning mount 10, the single planar element 52 is preferentially altered to form an inward support member 66 comprising a top end 66a and a lower angular end 66b having an angular value ranging 10 to 45 degrees from a line extending parallel to the positioning of the top mount surface, as illustrated by path R in FIG. 9. As further depicted in FIG. 9, the inward support member is selectively positioned perpendicular to the fore and aft leading edges 12a, 14a, 12b, 14b of the top and bottom mount surfaces 12, 14 with the top end 66a and lower angular end 66b thereof being integrally connected along centerlines C_{T}′, C_{B}′ extending midway in between and parallel to the left and right sides of the top and bottom mount surfaces, respectively.

As generally illustrated in FIGS. 1 and 8, upper and lower positioned corners 72, 74 formed by the union of the first and second sideward members with the left and right sides 12c, 14c, 12d, 14d of the top and bottom mount surfaces 12, 14, as represented in the second, alternative embodiment of the handlebar repositioning mount, and upper and lower positioned corners 76, 78 formed by the union of the first and second planar elements 16, 18 with the fore and aft leading edges 12a, 14a, 12b, 14b of the top and bottom mount surfaces, as represented in the preferred embodiment of the handlebar repositioning mount, each comprise a radius 72a, 74a, 76a, 78a to ease the transitional union of the aforementioned components and mitigate occurrence of injury in the event of inadvertent contact with the handlebar repositioning mount while positioned and mounted on the recreational vehicle 28.

Mounting of the handlebar repositioning mount 10 to the recreational vehicle, using either one of the foregoing embodiments representative thereof, initially involves removal of the stock handlebar mount assembly 22 from the stock steering column assembly 26, particularly from the column support plate 30. Once removed, the handlebar repositioning mount is placed onto and over the column support plate with the fore leading edges 12a, 14a of the top and bottom mount surfaces 12, 14 being directed toward a front portion 80 of the recreational vehicle 28 and the bottom mount surface 14 being tighteningly fastened to the column support plate with an appropriate number of supplementary mount bolts 48. After attachment in this manner, the lower clamping plate 36 of the stock handlebar mount assembly 22 is placed atop the top mount surface 12 followed by the placement of the handlebar set 24 into the concave runner 36a integral therewith. Consummating the assembly involves positioning the upper clamping plate 34 over the combined arrangement of the lower clamping plate 36 and handlebar set 24, aligning the first arrangement of apertures integral therewith, and fastening the assemblage with the requisite number of stock mount bolts 38 and hex nuts. In an alternative method of assembly, the top mount surface 12 may be interchangeable with that of the bottom mount surface 14, wherein the top mount surface is engaged with and fastened to the column support plate 30 and the bottom mount surface is positioned to receive the lower clamping plate 36 of the stock handlebar mount assembly 22 for fastening therewith. This arrangement has the effect of extending the steering column assembly more angularly outward toward the operator yet re-orientating the handlebar set 24 in a more vertical position. It is further contemplated during assembly that the top mount surface 12 of the handlebar repositioning mount 10 may be integrally connected to the lower clamping plate by means of a bead of weld placed along the perimeters thereof to yield greater rigidity and strength to the overall assembly while incorporated into the recreational vehicle 28. In this particular instance, the stock mount bolts 38 may be arranged to fit into and pass through the first arrangement of apertures present in the upper clamping plate 34 and terminate into threaded apertures (not shown) contained within the lower clamping plate 36 for secure fastening of the handlebar set 24 to the handlebar mount assembly 22 rather than the use of hex nuts tighteningly secured to the ends of the stock mount bolts. In an optional configuration, specifically to suit the needs of an exceptionally wide handlebar mount assembly exceeding the spatial requirements of one handlebar repositioning mount 10, two handlebar repositioning mounts may be used in a side-by-side relation, as shown in FIG. 5, where the first and second sets of apertures of the top and bottom mount surfaces and first and second arrangements of apertures present in the handlebar mount assembly and column support plate 30, respectively, are aligned accordingly to receive the requisite number of mount bolts. In this instance, the top and bottom mount surfaces present in each of the handlebar repositioning mounts may each comprise two apertures rather than the four shown in FIG. 1 to coincide and align with the first and second arrangements of apertures present most near left and right side portions 82, 84 of the handlebar mount assembly and column support plate, respectively.

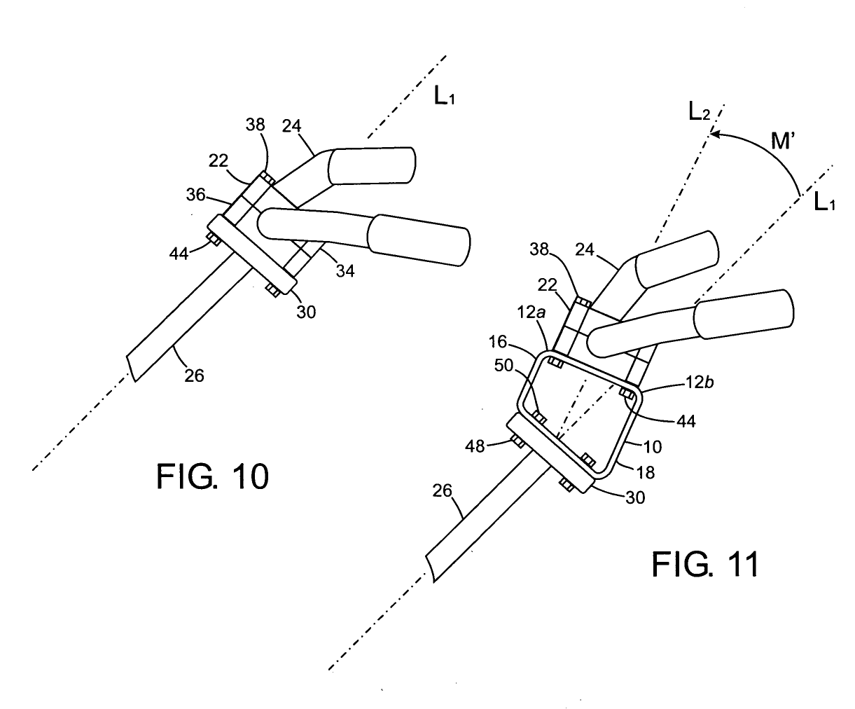

It can be seen from the foregoing that there is provided in accordance with this invention a simple and easily installed device, which is particularly suitable for adaptation to a steering column assembly 26 and handlebar set 24 generally associated with and present in stock and modified recreational vehicles, such as a snowmobile 28, an all-terrain vehicle, and a jet ski. The handlebar repositioning mount 10 is completely functional in terms of increasing the stock height and altering the stock angular position of the handlebar set 24 to principally establish a more upright, vertical orientation thereof, notably where the stock handlebar mount assembly and associated handlebar set collectively located along line L₁ in FIG. 10 move angularly upward along M′, the preferred angular relation, onto line L₂ in FIG. 11.

It is obvious that the components comprising the handlebar repositioning mount 10 may be fabricated from a variety of materials, providing such selection or use of materials possess the capacity to withstand the torsional forces acting thereon throughout its duration of use in a recreational or competitive setting, particularly upon its use in a recreational vehicle while engaging in high-speed turning maneuvers often associated with racing events. Accordingly, it is most desirable, and therefore preferred, to construct the entire handlebar repositioning mount as a unified structure from aluminum or equivalent, a material of which is considered as having a moderate strength-to-weight ratio while offering a reduced susceptibility to premature corrosion for sustained longevity in a performing environment. To lessen the cost and simplify construction, the handlebar repositioning mount 10 is preferably fabricated by means of extrusion techniques rather than by machining technology. An anodizing or chromate coating may be supplementary applied to the aluminum substrate of the handlebar repositioning mount to highlight its presence and increase its decorative appeal while mounted onto a recreational vehicle 28 in the manner specifically noted herein. Alternatively, the handlebar repositioning mount may receive a surface coating such as paint, preferentially being applied by powder coating techniques, to correspond with the existing decor of the recreational vehicle and function to mitigate surface deterioration and oxidation of the aluminum surface.

While there has been shown and described a particular embodiment of the invention, it will be obvious to those skilled in the art that various changes and alterations can be made therein without departing from the invention and, therefore, it is aimed in the appended claims to cover all such changes and alterations which fall within the true spirit and scope of the invention.

What is claimed is:

1. A handlebar repositioning mount for a recreational vehicle having a column support plate of a steering column assembly and upper and lower clamping plates of a handlebar mount assembly for situating thereinbetween a handlebar set, said repositioning mount comprising, in combination:
top and bottom mount surfaces each having fore and aft leading edges;
a first planar element having upper and bottom leading edges terminating at and connecting along said fore leading edges of top and bottom mount surfaces, respectively;
a second planar element having a length greater than that of said first planar element and upper and bottom leading edges terminating at and connecting along said aft leading edges of top and bottom mount surfaces, respectively; and
means for connecting said top and bottom mount surfaces to the lower clamping plate and column support plate, respectively.

2. A repositioning mount as set forth in claim 1, wherein said top and bottom mount surfaces and said first and second planar elements each comprise a predetermined width of equal value.

3. A repositioning mount as set forth in claim 1, wherein said connecting means comprises first and second sets of apertures extending through said top and bottom mount surfaces with each set of apertures substantially coinciding and aligning with first and second arrangements of apertures extending through the upper and lower clamping plates and column support plate, respectively, and an equivalent number of bolts passing through said sets of apertures and aligned arrangements of apertures and having ends threadably affixed with hex nuts.

4. A repositioning mount as set forth in claim 1, wherein said second planar element comprises a length of predetermined value to substantially establish an angular orientation of said bottom mount surface 10 to 45 degrees relative to said top mount surface.

5. A repositioning mount as set forth in claim 1, wherein said connecting means comprises a bead of weld positioned along the perimeters of said top mount surface and lower clamping plate upon their engagement with one another and a set of apertures extending through said bottom mount surface which substantially coincide and align with a second arrangement of apertures extending through the column support plate and an equivalent number of bolts passing through said set of apertures and aligned arrangement of apertures and having ends threadably affixed with hex nuts.

6. A repositioning mount as set forth in claim 1, wherein said top and bottom mount surfaces and said first and second planar elements are fabricated as a unified structure and made from aluminum.

7. A handlebar repositioning mount for a recreational vehicle having a column support plate of a steering column assembly and upper and lower clamping plates of a handlebar mount assembly for situating thereinbetween a handlebar set, said repositioning mount comprising, in combination:
top and bottom mount surfaces each having fore and aft leading edges and a centerline substantially extending midway in between and parallel to said fore and aft leading edges;
a single planar element having an upper end and a lower angular end terminating at and connecting along said centerlines of top and bottom mount surfaces, respectively; and
means for connecting said top and bottom mount surfaces to the lower clamping plate and column support plate, respectively.

8. A repositioning mount as set forth in claim 7, wherein said connecting means comprises first and second sets of apertures extending through said top and bottom mount surfaces with each set of apertures substantially coinciding and aligning with first and second arrangements of apertures extending through the upper and lower clamping plates and column support plate, respectively, and an equivalent number of bolts passing through said sets of apertures and aligned arrangements of apertures and having ends threadably affixed with hex nuts.

9. A repositioning mount as set forth in claim 7, wherein said lower angular end of single planar element comprises an angular value ranging 10 to 45 degrees to substantially yield a corresponding angular position of said bottom mount surface relative to said top mount surface.

10. A repositioning mount as set forth in claim 7, wherein said top and bottom mount surfaces and said single planar element are fabricated as a unified structure and made from aluminum.

11. A repositioning mount as set forth in claim 7, wherein said connecting means comprises a bead of weld positioned along the perimeters of said top mount surface and lower clamping plate upon their engagement with one another and a set of apertures extending through said bottom mount surface which substantially coincide and align with a second arrangement of apertures extending through the column support plate and an equivalent number of bolts passing through said set of apertures and aligned arrangement of apertures and having ends threadably affixed with hex nuts.

12. A handlebar repositioning mount for a recreational vehicle having a column support plate of a steering column assembly and upper and lower clamping plates of a handlebar mount assembly for situating thereinbetween a handlebar set, said repositioning mount comprising, in combination:
top and bottom mount surfaces each having fore and aft leading edges and left and right sides;
first and second sideward members each having a top end terminating at and connecting along said left and right sides of top mount surface, respectively, to form a pair of upper positioned corners and an angular bottom end terminating at and connecting along said left and right sides of bottom mount surface, respectively, to form a pair of lower positioned corners; and
means for connecting said top and bottom mount surfaces to the lower clamping plate and column support plate, respectively.

13. A repositioning mount as set forth in claim 12, wherein said angular bottom ends of first and second sideward members each comprise an angular value of equal value ranging 10 to 45 degrees to substantially yield a corresponding angular position of said bottom mount surface relative to said top mount surface.

14. A repositioning mount as set forth in claim 12, wherein said upper and lower positioned corners each comprises a radius of a predetermined value.

15. A repositioning mount as set forth in claim 12, wherein said connecting means comprises first and second sets of apertures extending through said top and bottom mount surfaces with each set of apertures substantially coinciding and aligning with first and second arrangements of apertures extending through the upper and lower clamping plates and column support plate, respectively, and an equivalent number of bolts passing through said sets of apertures and aligned arrangements of apertures and having ends threadably affixed with hex nuts.

16. A repositioning mount as set forth in claim 12, wherein said connecting means comprises a bead of weld positioned along the perimeters of said top mount surface and lower clamping plate upon their engagement with one another and a set of apertures extending through said bottom mount surface which substantially coincide and align with a second arrangement of apertures extending through the column support plate and an equivalent number of bolts passing through said set of apertures and aligned arrangement of apertures and having ends threadably affixed with hex nuts.

17. A handlebar repositioning mount for a recreational vehicle having a column support plate of a steering column assembly and upper and lower clamping plates of a handlebar mount assembly for situating thereinbetween a handlebar set, said repositioning mount comprising, in combination:
top and bottom mount surfaces each having left and right sides and a centerline substantially extending midway in between and parallel to said left and right sides;
an inward support member having a top end and a lower angular end terminating at and connecting along said centerlines of top and bottom mount surfaces, respectively; and
means for connecting said top and bottom mount surfaces to the lower clamping plate and column support plate, respectively.

18. A repositioning mount as set forth in claim 17, wherein said lower angular end of inward support member comprises an angular value ranging 10 to 45 degrees to substantially yield a corresponding angular position of said bottom mount surface relative to said top mount surface.

19. A repositioning mount as set forth in claim 17, wherein said connecting means comprises first and second sets of apertures extending through said top and bottom mount surfaces with each set of apertures substantially coinciding and aligning with first and second arrangements of apertures extending through the upper and lower clamping plates and column support plate, respectively, and an equivalent number of bolts passing through said sets of apertures and aligned arrangements of apertures and having ends threadably affixed with hex nuts.

20. A repositioning mount as set forth in claim 17, wherein said connecting means comprises a bead of weld positioned along the perimeters of said top mount surface and lower clamping plate upon their engagement with one another and a set of apertures extending through said bottom mount surface which substantially coincide and align with a second arrangement of apertures extending through the column support plate and an equivalent number of bolts passing through said set of apertures and aligned arrangement of apertures and having ends threadably affixed with hex nuts.
